(19) United States
(12) Patent Application Publication
(10) Pub. No.: US 2022/0028212 A9
(43) Pub. Date: Jan. 27, 2022

(54) WAGERING GAME SKILL DETECTION AND AWARDING SYSTEMS AND METHODS

(71) Applicant: Shuo YANG, Pomona, CA (US)

(72) Inventor: Shuo YANG, Pomona, CA (US)

(21) Appl. No.: 15/889,203

(22) Filed: Feb. 5, 2018

Related U.S. Application Data
(60) Provisional application No. 62/454,712, filed on Feb. 3, 2017.
(60) Provisional application No. 62/485,327, filed on Apr. 13, 2017.

(51) Int. Cl. G07F 17/32

(52) U.S. Cl. CPC G07F 17/3237; G07F 17/3272; G07F 17/3244

(57) ABSTRACT

Systems, methods and apparatus for providing, operating, hosting and conducting a wagering game in which player game activity, such as selections, decisions, actions taken (or inactions) by the player during gaming events in the wagering game are analyzed at the time such game event data is generated to determine a player rating and skill value and distribute skill based awards between players.

### CROSS-REFERENCE TO RELATED APPLICATIONS

This application claims the priority benefit of U.S. Provisional Patent Application No. 62/454,712 filed Feb. 3, 2017 and U.S. Provisional Patent Application No. 62/485,327 filed Apr. 13, 2017, the disclosures of which are incorporated herein by reference.

### BACKGROUND OF THE INVENTION

The invention generally relates to systems and methods of providing, hosting and conducting wagering games, and in particular, the invention relates to systems and methods for providing a player rating system for assessing player skill exhibited during play of a poker room-type wagering game in which players compete against other players.

### DESCRIPTION OF THE RELATED ART

Many wagering games are considered to be determined entirely by chance while others are considered to be determined by a combination of skill and chance. For example, the outcome of Blackjack may be considered to require a combination of skill and chance.

Unlike conventional Blackjack, which involves players competing against a casino or “house”, some wagering games are configured such that players compete against other players. These wagering games are often played either round by round, or as a contest or tournament involving multiple rounds of play. Poker games, such as Texas Hold'em, are examples of games which can involve players competing against one another. In Texas Hold'em tournaments, the player having won all the money from all other players is deemed to be the winner.

By way of background, in Texas Hold'em, each player receives two pocket cards. A round of betting occurs after the pocket cards are dealt, followed by the display of three community cards, called the “flop.” A second round of betting occurs, followed by the display of a fourth community card, called the “turn,” or “fourth street.” A third round of betting then occurs, followed by the display of a fifth community card, called the “river” or “fifth street.” A final round of betting occurs, after which the players determine the winner, in a process called the “showdown.” The winner is the player among the players remaining in the game who has the highest ranked hand formed from any of the player's pocket cards and the community cards. The winner receives all the accumulated bets in the pot. Since there are two pocket cards available to each player, and only five community cards, it is likely that the highest ranked hand will utilize pocket cards, and the chances for a tie hand are relatively less than in a game with fewer pocket cards and more community cards. Additionally, since a full hand of five cards is available after the first round of betting, players will be likely to fold if they fail to make a ranked hand when the first three community cards are dealt.

It should be readily apparent that, while rounds may be won by luck, winning a tournament requires skill. Though skill is needed to win tournaments, rating players can be difficult because the impact of chance and the skill of other players involved are not easily quantifiable for comparative purposes. Identifying skilled play, for reasons such as assigning awards or rating players against one another, would be advantageous, at least because it would increase interest and draw attention to tournament play. For example, awarding or rating players can be used for marketing purposes such as by providing player rewards and advertising a leaderboard. Accordingly, it would be desirable to have a rating system that focuses on the skill of players in wagering games in which skill and chance are factors.

### SUMMARY OF THE INVENTION

The invention is generally directed to systems, methods and apparatus for providing, operating, hosting and conducting a wagering game in which player game activity, such as selections, decisions, actions taken (or inactions) by the player during gaming events in the wagering game are analyzed at the time such game event data is generated to determine a player rating and skill value and distribute skill based awards between players.

Some embodiments of the invention are directed to a gaming system, comprising: at least one processor; at least one input device; and at least one memory device that stores a plurality of instructions that, when executed by the at least one processor, cause the at least one processor to operate with the at least one display device and the plurality of input devices to: (a) establish a first player account with a credit balance associated with a first player; (b) accept the first player in a wagering game involving play against one or more second players, each second player having a second player account; (c) responsive to the occurrence of a game event requiring a player action, receive game event data relating to the first and second player actions and game conditions at the occurrence of the game event; (d) determine a rank of each of the first and second player actions based at least partially on the game conditions; (e) distribute one of (i) an award from a second player to the first player as an indicator of skilled play responsive to the rank of the first player action outranking the rank of the second player action and (ii) an award from the first player to the second player as an indicator of skilled play responsive to the second player action outranking the rank of the first player action; and (f) display the distributed award in the first or second player account.

Some embodiments of the invention are directed to a computer implemented gaming method having a feature for distributing awards for skilled game play, comprising the steps of: a) establishing a first player account with a credit balance associated with a first player; b) accepting the first player in a wagering game involving play against one or more second players, each second player having a second player account; c) responsive to the occurrence of a game event requiring a player action, receiving game event data relating to the first and second player actions and game conditions at the occurrence of the game event; d) determining a rank of each of the first and second player actions based at least partially on the game conditions; e) distributing one of (i) an award from a second player to the first player as an indicator of skilled play responsive to the rank of the first player action outranking the rank of the second player action and (ii) an award from the first player to the second player as an indicator of skilled play responsive to the second player action outranking the rank of the first player action; and f) displaying the distributed award in the first or second player account.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of various examples of gaming systems which may be used with embodiments of the invention;

FIG. 2 is a flowchart illustrating a method of operating an exemplary embodiment of the gaming system of the invention;

FIG. 3 is a flowchart illustrating a method of operating another exemplary embodiment of the gaming system of the invention;

FIG. 4 is a chart showing exemplary calculations for analysis of player actions and game event data;

FIG. 5 is a perspective view of an individual electronic gaming device configured for implementation of embodiments of wagering games in accordance with this disclosure;

FIG. 6 is a schematic diagram depicting the components of an exemplary platform configured and constructed according to some embodiments of the invention;

FIG. 7 is a schematic block diagram of another platform for implementing some embodiments of games of the invention;

FIG. 8 is a block diagram of a computer for acting as a gaming system for implementing embodiments of wagering games in accordance with this disclosure.

### DETAILED DESCRIPTION OF THE INVENTION

The following detailed description provides systems and methods for implementing features in gaming applications. The gaming applications may be implemented in accordance or in conjunction with one or more of a variety of different types of gaming systems, such as those described herein, including computer based platforms which may be specially configured for the provision of wagering games, such as electronic player terminals, multiplayer platforms, electronic gaming machines, or other devices which are not specially configured for the provision of wagering games, such as a smartphone, that can be enabled as a platform or device through which such features of the invention can be made accessible during game play. Embodiments of the invention therefore contemplate a variety of different gaming systems each having one or more of a plurality of different features, attributes, or characteristics as disclosed herein.

It should nonetheless be understood that certain devices of those discussed herein may include and be implemented with special features and/or additional circuitry that differentiates them from general-purpose computers (e.g., desktop PC's and laptops). Devices used for gaming, such as multiplayer devices, gaming terminals, and electronic interfaces provided at physical gaming tables on the gaming floor or in poker rooms, are highly regulated to ensure fairness and security, in many cases, gaming devices are operable to dispense substantial monetary awards. Therefore, to satisfy security and regulatory requirements in a gaming environment, hardware and software architectures may be implemented in gaming machines that differ significantly from those of general-purpose computers. For example, an important difference between gaming devices and common personal computer based computer systems is that a gaming device must demonstrate sufficient safeguards that prevent an operator or player of a gaming device from manipulating hardware and software in a manner that gives them an unfair and some cases an illegal advantage. Gaming devices will have a means to determine if the code it will execute is valid, and if the code is not valid, the gaming device will have a means to prevent the code from being executed. Gaming devices may also have unique requirements that differ from a personal computer, such as peripheral security requirements not usually addressed by personal computers. For instance, monetary devices, such as coin dispensers, bill validators and ticket printers and computing devices that are used to govern player accounts, credit and debit player account balances and handle the input and output of cash to a gaming device have security requirements that are not typically addressed in personal computers. Therefore, many personal computer techniques and methods developed to facilitate device connectivity and device compatibility do not address the emphasis placed on security in the gaming industry.

The foregoing notwithstanding, features of the invention may be implemented on gaming devices and other devices which are not specially configured for the provision of a wagering game and thus often lack certain components typically included in a gaming device. In instances where such gaming device specific components are lacking, suitable measures are taken to address similar issues, including issues of security and game integrity, as well as issues relating to establishing secure player accounts and handling monetary transfers despite any lack of specific gaming device hardware for addressing such issues. Accordingly, a gaming system as used herein refers to various configuration that may include one or more central servers, central controllers, or remote hosts, one or more gaming devices and/or one or more devices which are not specially configured for the provision of a wagering game, such as desktop computers, laptop computers, tablet computers or computing devices, televisions, personal digital assistants (PDAs), mobile telephones such as smart phones, and other mobile computing devices hereinafter collectively referred to as gaming devices. Thus, in various embodiments, the gaming system of the present disclosure includes one or more gaming devices of any kind in combination with one or more central servers, central controllers, or remote hosts. The gaming devices may be configured to communicate with the central server, central controller or remote host through a communication link, such as a local or wide area data network, closed, intranet or open system or remote link such as the Internet.

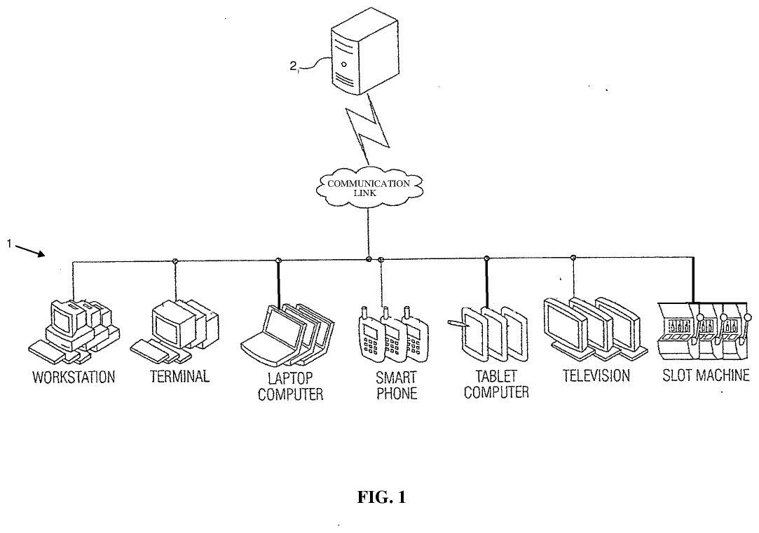

FIG. 1 illustrates a schematic of exemplary gaming system hardware and network platform that can be used to implement embodiments of the invention. The system includes gaming devices which are in communication with one or more central servers 2 through one or more communication links, which may include a data networks and the internet. Exemplary gaming devices 1 shown in FIG. 1 include slot machines, workstations, terminals (including self-service wagering terminals and terminals installed in a gaming table), laptops or other internet connected computing systems, mobile or smart phones, tablet computers and televisions. Additionally, for brevity and clarity, unless specifically stated otherwise, “gaming device” as used herein represents one gaming device or a plurality of gaming devices, and “central server, central controller, or remote host” as used herein represents one central server, central controller, or remote host or a plurality of central servers, central controllers, or remote hosts.

In certain embodiments in which the gaming system includes a gaming device in combination with a central server, central controller, or remote host, the central server, central controller, or remote host is any suitable computing device (such as a server) that includes at least one processor and at least one memory device or storage device. As further described below, the gaming device includes at least one processor configured to transmit and receive data or signals representing events, messages, commands, or any other suitable information or data between the gaming device and the central server, central controller, or remote host, including player data and gameplay data. The at least one processor of that gaming device is configured to execute the events, messages, or commands represented by such data or signals in conjunction with the operation of the gaming device. Moreover, the at least one processor of the central server, central controller, or remote host is configured to transmit and receive data or signals representing events, messages, commands, or any other suitable information between the central server, central controller, or remote host and the gaming device. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the gaming device. It should be further appreciated that one, more, or each of the functions of the at least one processor of the gaming device may be performed by the at least one processor of the central server, central controller, or remote host.

In certain such embodiments, computerized instructions for controlling any games (such as any primary or base games and/or any secondary or bonus games) displayed by the gaming device are executed by the central server, central controller, or remote host. In “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the EGM and are stored in at least one memory device of the gaming device. In “thick client” embodiments, the at least one processor of the gaming device executes the computerized instructions to control any games (or other suitable interfaces) displayed by the gaming device. In some embodiments, certain functions of one or more of the gaming devices are implemented in a thin client environment, and certain other functions of one or more of the gaming devices are implemented in a thick client environment.

The gaming devices may be configured to communicate with one another and/or a central server, central controller or remote host through a data network, the data network is a local area network (LAN), a wide area network (WAN), internet or an intranet. In certain such embodiments, a mobile application is used or an internet browser of the gaming device is usable to access an internet game page from any location where an internet connection is available. In one such embodiments, after being accessed, the central server, central controller, or remote host identifies a player and, if applicable, the player age and location, prior to enabling that player to place any wagers in a game provided by the gaming system. In one example, the central server, central controller, or remote host identifies a player by requiring a player account of the player to be established and then subsequently logged into via an input of a unique username and password combination assigned to the player from an appropriate location. It should be appreciated, however, that the central server, central controller, or remote host may identify the player and the player location, if applicable, in any other suitable manner, such as by validating a player tracking identification number associated with the player; by reading a player tracking card or other smart card inserted into a card reader; by validating a unique player identification number associated with the player by the central server, central controller, or remote host; or by identifying the gaming device and its location, such as by identifying the MAC address or the IP address of the internet facilitator.

It should be appreciated that the central server, central controller, or remote host and the gaming device are configured to connect to the communication link, data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In various embodiments, a gaming device includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASIC s).

As generally noted above, the at least one processor of the gaming device is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). It should be appreciated that any other suitable magnetic, optical, and/or semiconductor memory may operate in conjunction with the gaming device disclosed herein. In certain embodiments, the at least one processor of the gaming device and the at least one memory device of the gaming device both reside within a gaming device housing. In other embodiments, at least one of the at least one processor of the gaming device and the at least one memory device of the gaming device reside outside the gaming device housing.

In certain embodiments, as generally described herein, the at least one memory device of the gaming device stores program code and instructions executable by the at least one processor of the gaming device to control the gaming device. The at least one memory device of the gaming device also stores other operating data, such as image data, event data, input data, random number generators (RNGs) or pseudo-RNGs, paytable data or information, and/or applicable game rules that relate to the play of one or more games on the gaming device (such as primary or base games, such as poker, and/or secondary or bonus games which may include proposition wagers on game events, slot games or other casino gaming). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a casino poker room operator) and/or a player uses such a removable memory device in an gaming device to implement at least part of the present disclosure. In other embodiments, part or all of the program code and/or the operating data is downloaded to the at least one memory device of the gaming device through any suitable data network described above (such as an internet or intranet).

In various embodiments, the gaming device includes one or more input devices. The input devices may include any suitable device that enables an input signal to be produced and received by the at least one processor of the gaming device. One input device of the gaming device may be a payment device configured to communicate with the at least one processor of the gaming device to fund the gaming device or a player account which is capable of funding the gaming device. In certain embodiments, the payment device includes one or more of: a bill acceptor into which paper money is inserted to fund the gaming device; a ticket acceptor into which a ticket or a voucher is inserted to fund the gaming device; a coin slot into which coins or tokens are inserted to fund the gaming device; a reader or a validator for credit cards, debit cards, or credit slips into which a credit card, debit card, or credit slip is inserted to fund the gaming device; and a player identification card reader into which a player identification card is inserted to fund the gaming device. In some embodiments, the gaming device includes a payment device configured to enable the gaming device to receive funds via an electronic funds transfer, such as a transfer of funds from a bank account, or other account configured for electronically transferring funds from a bank account, or through accepting of cryptocurrency from an exchange thereof. In another embodiment, the gaming device includes a payment device configured to communicate with a mobile device of a player, such as a cell phone, a radio frequency identification tag, or any other suitable wired or wireless device, to retrieve relevant information associated with that player to fund the gaming device. It should be understood that funding a gaming device as used herein means both providing funds directly to a gaming device or an intermediary device or a player account accessible on or through a gaming device. It should be appreciated that when the gaming device is funded, the at least one processor determines the amount of funds received and displays the corresponding amount on a credit display or any other suitable display. A display device associated with the gaming device may be a touch-screen coupled to a touch-screen controller or other touch-sensitive display overlay to enable interaction with any images displayed on a display device, such as a conventional touch-screen button panel. Display devices may include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the gaming device are configured to display one or more game and/or non-game images, symbols, and indicia. In certain embodiments, the display devices of the gaming device are configured to display any suitable visual representation or exhibition of the movement of objects; dynamic lighting; video images; images of people, characters, places, things, and faces of cards; and the like. In certain embodiments, the display devices of the gaming device are configured to display one or more poker games, including representations of playing cards, a gaming table and gameplay activity. In other embodiments, certain of the displayed images, symbols, and indicia are in mechanical form. That is, in these embodiments, the display device may provide for certain functionality and decision making, such as, funding a player account, placing wagers in the game, making gameplay decisions, etc., whereas the playing cards may be physically dealt and either provided to a player seated at the table or displayed to a player remotely through a video communication link.

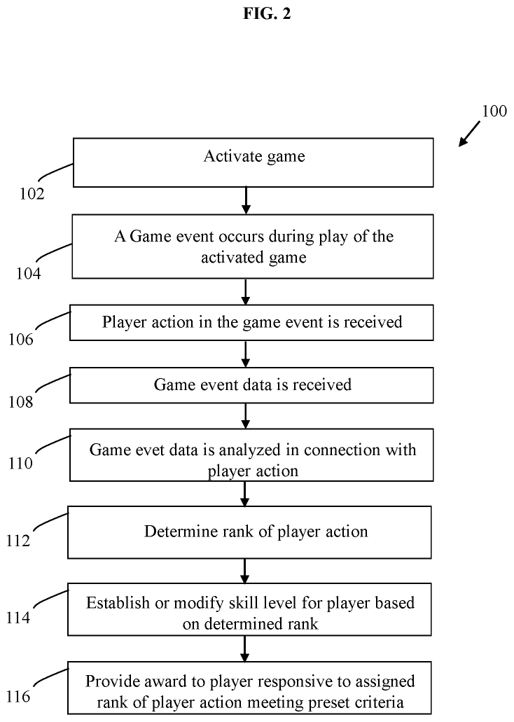

FIG. 2 illustrates a flowchart of an exemplary embodiment of a process or method 100 of operating the gaming system of the invention, which may be represented by a set of instructions stored in one or more memories and executed by one or more processors which may be in communication with one or more random number generators.

In some embodiments a gaming system of the invention is configured to identify skilled game play while operating in connection with the operation of a game. In this embodiment, the game is of a type in which a successful outcome may be a function of the exhibition of both skill and chance, such as games like poker, blackjack or any game involving player decision making and randomly generating results used in the play of the game, such as dealing from a deck of randomly-ordered playing cards to form a hand of playing cards or rolling dice to obtain a dice roll result.

As shown by block 102, an instance of a game is activated, which in some instances involves the placing and receipt of one or more wagers. In block 104, a game event occurs during play of the game in which a player decision may be made. Depending on the game and circumstances, the player may be required to make a decision or such decision may be optional. A player action is taken is block 106. The term “action” as used herein includes an inaction or a decision to take any no action. Game event data is received in block 108 and game event data is analyzed in block 110 in connection with the player action.

Game event data includes information regarding the various conditions existing at the occurrence of the game event, some of which may be known only to a player and some of which may be unknown to the player. For example, game event data may include information relating to player-specific conditions at the game event such as the player's likelihood of winning the game given the player's standing, game position or hand at the occurrence of the game event, and the player's likelihood of winning the game after the game event if the conditions have changed. For example, in the game of poker, player conditions at the game event can include the cards in a player's hand, the rank of the player's hand, the potential rank, the amount the player has placed at stake, the player's wager and/or raise of another's wager, and in the case of tournament play, the player's remaining credit or chips. In some embodiments, game event data includes any game information currently available to a player at the occurrence of a game event from which a player presumably makes a decision to execute a player action in block 106.

The game event data may further include game play information relating to the instance of the game and current game-related conditions as of the game event, such as the pot amount, number of players in the game, the blind amounts, actions by other players such as wagers and/or raises, other player hands. Information available to a player such as any revealed cards in a community group of cards, the player's hand or other players' hands or any other information providing partial hand information for the player or others. In this embodiment, game play conditions at the game event includes information about the game which the player may not be aware of at the time a decision is made, such as the hand rank of other player hands in the game, and which may or may not relate to a player's likelihood of winning the instance of the game.

The analysis of the game event data in connection with a player in block 110 is configured to determine, as shown by block 112, a value or rank of the player action taken in the step of block 106 based on the game event data received in the step of block 108. In some embodiments, the analysis of the game event data includes establishing a hierarchy of actions for a particular skill, such as by assigning a value or rank to each potential player action presented by the game event shown by block 104, and then comparing the actual action taken in step 106 with the potential actions and ranks relating thereto to determine the appropriate rank for the player action taken in step 106. In some embodiments, the assigned ranks of the potential player actions may determined based on the least to most appropriate player action, such as wagering, calling or folding, based on the game event data, which also considers other factors such as the amount at stake. The hierarchy of ranks may be expressed in any form, such as numerical values or categorically. For example, ranks may be expressed as experience levels, such as novice, beginner, intermediate, expert, master, etc. The ranks may relate to specific skills relating to the game, such as skill in bluffing in poker or skill in hitting in Blackjack.

Once a rank is determined in block 112 it is used in assigning, determining or modifying a skill level for the player, as shown by block 114. The skill level can be used for various purposes, such as for assigning awards or award points to the player, identifying the most skilled players, adjusting the player's skill level, rank or rating accordingly. For example, if the player action is equal to the low value action then it will have a negative impact, such as the loss of awards or lowering of a player skill rating for example. Player skill ratings and/or respective number of awards may be used to place players into games or tournaments with other players of a similar skill rating.

As shown by block 116, if the assigned rank meets a certain preset criteria, such as expert designation or better, the player will be provided with an item as an award for skilled play in the game. The item may be something of monetary value or non-monetary value. In some embodiments, the indicator of skilled play is a graphical representation of a badge or trophy which will be displayed in a player profile or player position of a gaming device display. In some embodiments, the indicator is non-transferrable by players to other players. In some embodiments, an indicator may be awarded and then lost as a result of a player's action during a game event. In some embodiments, an indicator may be lost as a result of game event data revealing that another, second player's action exhibited greater skill in the particular subject area than the first player's action during the game event. In such embodiments, the indicator may be removed from the first player and transferred to the second player as a result of being outplayed.

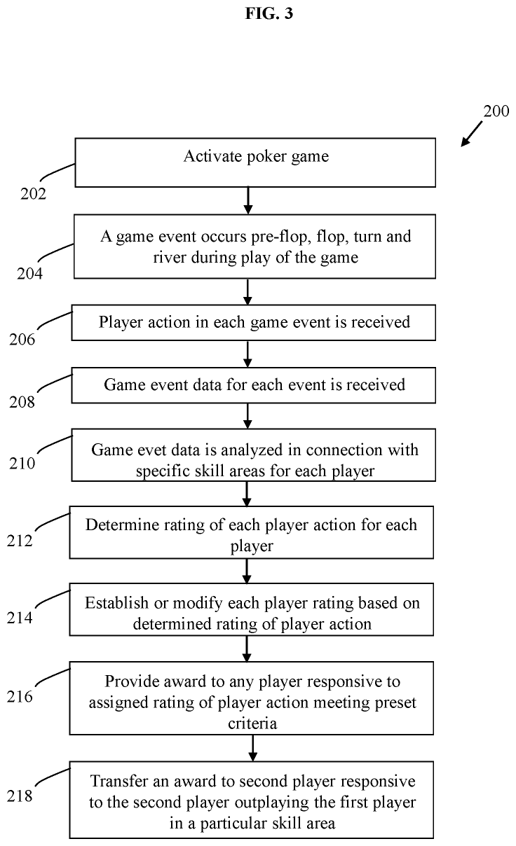

FIG. 3 illustrates another embodiment of the invention in which the game is Texas hold'em poker. As shown by block 204, game events include the pre-flop wagering event, the flop, turn and river. As shown by blocks 206 and 208, player actions and game event data for each game event, should they occur during play of the game, are received, and subsequently analyzed as shown by block 210 to determine a player rating based on the player action as shown by block 212. In this embodiment, specific skill areas are analyzed, such as the bluffing, trapping, avoiding traps or calling bluffs. Player actions of relevance may therefore include wagering or folding, and game event data may include the player's hand rank. For example, a player raising a wager on a low ranked hand to get another player with a higher rank handed to fold would relevant game event data for determining player skill.

Game event data may also include information such as the relative strength of the player hand, the number of players in the game and amount at stake in the pot at the time of the player action. A value or hand equity may be assigned to the player hand based the determination of the relative strength of the hand. The amount at stake may be adjusted based the number of players in the game. The relative strength of the player hand may be based on the rank of the player hand, including any revealed community cards or other player cards, only, that is, the information available to the player at the time a player action is to be made. In other embodiments, the relative strength of the hand and determination of a player hand equity may be based on the probability of the player winning in consideration of game event data such as other player hands at the time of the player action. In some embodiments, both the rank of the player hand and the probability of the player winning based on all remaining hands in the game are factors in determining a hand equity value. The analysis may also be based on comparison of the game event data with a model designed to exemplify expert play under any circumstances. The model may be adjusted or the analysis may also include a method for determining and assessing certain actions which may not be in accordance with expert play, but which are just as effective, or even more so, such as a successful bluff or trap in a poker game against other players.

Any modification to the player rating is actuated as shown in block 214 and should an award assigned to the player as shown by block 216, if appropriate. As shown by block 218, should another player, that is, a second player, outplay a first player in a particular skill area being analyzed as shown in block 210, an award previously granted to the first player is transferred to the second player.

The assigning of awards or adjustment of the player's skill rating based on the determined rank may depend on the result of the player action. For example, if the player's action results are favorable to the player, then the player may receive an award and/or the player's skill rating will be adjusted upward. If the player action results are unfavorable to the player then the player may lose an award and/or the player's skill rating will be adjusted downward. In short, the determination or adjustment of a skill rating and/or the assignment or deduction of an award, may be based partially on a player's chosen actions relative to the game data and player data, and partially on the response or results of the player's chosen actions. In some embodiments, the gaming systems and methods of the invention, including its algorithms, assess an entire game event, that is, using player-specific conditions and game conditions before a player's actions and again subsequent to the player's actions when responses to such player's actions are detected. In some instances, each game event may begin with the first player's actions and end upon all player's having acted, such as folded, wagered, called, raised, re-raised, lost, won, etc., such as shown in blocks 204 and 206.

For example, as discussed above, instances of bluffs and called bluffs may be detected by comparing the game event data, such as the comparative hand values or ranks, players in the game, wagers or raises made or amount at stake in the pot, to preset criteria, such as the player making a wager that is not determined by the system to be commensurate with the rank of the player's hand or a player calling a wager made by another player placing a wager that is not commensurate with the rank of that player's hand. Thus, the system of the invention first determines a normative range of actions based on the game and player data, such as a normative range of wager amounts. The system then compares the action player action to determine whether it is within the normative range. If the player's action is outside of the normative range then system determines if certain conditions are present for purposes of identifying a specific categorical instance of possible skill exhibition, such as a bluff or called bluff. A bluff or called bluff would involve placing a wager which is outside of the normative range based on the game and player data, including the player's hand placing the wager and/or the player's hand calling the wager. Should the bluff be successful, then the system determines this to be an exhibition of skill by the player and assigns a skill indicator, such as a trophy to the player. In some embodiments, the skill indicators are awarded to one or more players as a result of such an event via a zero sum process involving the transfer or debiting of a skill indicator from one or more other players. For example, a player that successfully bluffs or calls another's bluff, is awarded one or more skill indicators while the player that was either bluffed or had their bluff called loses an equal amount of one or more skill indicators.

In some embodiments, the skill indicators may be used in some ways to rank players or otherwise determine a player skill rating. Under certain conditions set forth in the player and/or game data, a player action which might normally be considered inappropriate and assigned a low value, such as placing a high wager amount on a hand of low strength (that is, a “bluff” in the game), may result in the transfer of skill indicators to the player and/or an adjustment of the player's skill rating upward should the results be favorable to the player. Since bluffing is an important exhibition of skill based on the player and game conditions during play of the game, the invention advantageously provides the opportunity for players to achieve higher rating by bluffing. Accordingly, a successful bluff may earn a player a higher player rating than if the player takes a player action that is assigned an average ranking by the system, even if the player action assigned to be average has favorable results. A called bluff can result in a higher player rating. A called bluff may be a player action in which a first player calls a wager made by a second or other players having a hand of a lower equity value if that second player wagers an amount determined to be an inappropriately high amount based on the second players low hand equity.

The setting of a trap, in which a second or other players are “tricked” into placing a higher wager than is determined to be appropriate based on their hand equity value, when a first player has a hand of higher equity, can also be an example of circumstances which are exhibitive of skill.

In an exemplary embodiment of the invention each player's hand has an equity associated with it. The equity of a player's hand is the probability that the player will win given the player data regarding the player's hand and the game data including the other players' hands and the board. The average equity (A) varies based on the number of players active. The average equity is defined by the following formula: A=100%/N where N=number of players still participating with a hand in game (e.g., If there are 3 un-folded players remaining in the round at the time of the player action, then the average equity is 100%/3=33%). The Effective Pot (EP) is the greater of the pot amount (P) and Base Pot (BP) amount, where: BP=Players still in hand x Big Blind Amount×Big Blind (BB) Multiplier. It should be noted that the BB Multiplier is a value to be set by the specific implementation or embodiment. The greater the BB Multiplier is, the greater the BP is during pre-flop. Thus, betting×2 BB during pre-flop while there is no pot yet is not seen as “over” betting and thereby triggering the start of a “bluff” sequence. Effectively, the greater the BB Multiplier is, the harder it is to start a “bluff” in the pre-flop round. In other words, the greater the BB Multiplier is, the more a player has to bet during pre-flop to start a potential “bluff” sequence.

For example, if BB Multiplier is set to be: 3.5 and Big Blind is 2, then the EP of a 3 players having a hand in the round before the flop (pre-flop) is as follows: BP=3×2×3.5=$21. If the Pot (P) is less than BP, then the BP will be used as EP. This is primarily to guard against cases where the POT is relatively small, e.g., pre-flop or when players just have not bet very much during the round.

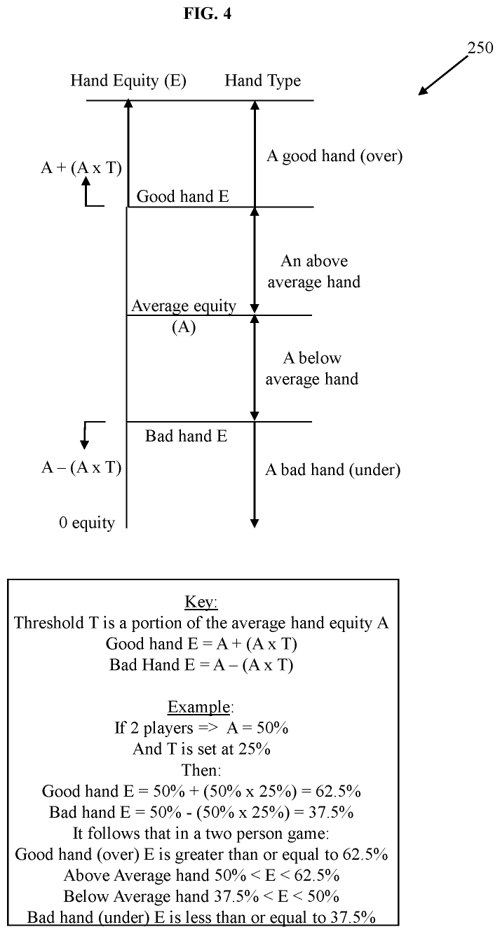

Each hand is tiered or ranked as follows based on the cards in the player hand: Under—bad hand; Below average—somewhat bad hand; Above average—somewhat good hand; Over—good hand. FIG. 4 illustrates a chart 250 of exemplary hand type calculations. As shown therein, threshold T is a percentage, where the bigger the threshold is, the further away from A good hand E and bad hand E will be. For example, if T is set at 25%, a player's equity has to be 25% of A greater than A to be considered a good hand. Similarly, it means that bad hand E(quity) has to be 25% of A less than A (as can be seen in the chart of FIG. 4). T can be set according to how sensitive skill detection is desired to be. 25% is usually a good number. Below is a table of good/bad hand equities given T=25%

TABLE
Good/bad hand equity ranges by active player count

| Active Players Count | Threshold Percentage | Good | Bad |
|---|---|---|---|
| 2 | 25 | 62.5 | 37.5 |
| 3 | 25 | 41.7 | 25.0 |
| 4 | 25 | 31.3 | 18.8 |
| 5 | 25 | 25.0 | 15.0 |
| 6 | 25 | 20.8 | 12.5 |

Each player action (bet) is tiered as follows:
Under—significantly below an equitable bet
Below average—somewhat below an equitable bet
Above average—somewhat above an equitable bet
Over—very much above an equitable bet
   i.e.:
a bet is an “under” bet if the bet amount is
   less than EP×Bad Hand Equity (BHE)
a bet is a “below average” bet if the bet amount is
   greater than EP×BHE
   but less than EP×A
a bet is an “above average” bet if the bet amount is
   greater than EP×A
   but less than EP×Good Hand Equity (GHE)
a bet is a an “over” bet if the bet amount is
   greater than EP×GHE
      Each potential call is considered similarly according to the above:
Under
Below average
Above average
Over

### Good Fold (Dodged a Bullet)

When player has not tried a trap or bluff and folded a hand and:
1. A call would have been two or more tiers above the player's hand

### Bluff (Stole the Pot)

Two conditions must be met in sequence:
1. player's bet must be two or more tiers above his hand
2. subsequently, all players must fold without calling

### Called Bluff

Two conditions must be met in sequence:
1. a previous player must have bluffed
2. player calls or raises with either an Above average or an Over hand

### Trap

Following conditions must be met in sequence:
1. Player either checks or bets (but not call)
2. Player hand type must be two or more tiers above player's bet (an under bet)
   1. a check is considered betting 0, which is an under bet
3. Victim then bets two or more tiers above his hand
4. Player calls or re-raises

### Taunt

Following conditions must be met in sequence:
1. Player with an Over hand bets Above average or Over.
2. Victim then bets two or more tiers above his hand

As discussed above, in some embodiments of the invention players may be awarded the trophies or awards previously awarded to other players based on certain actions and events occurring in the game. For example, a first player may win a “bluff” badge from a second player, if that first player successfully bluffed the second player. In these embodiments, the exchange of such awards, badges or trophies from one player to another may be visually indicated to all players through a display screen, such that all the players involved in the game, and possibly others, are made aware of the underlying circumstances of the event which led to the exchange. As such, players are provided with information about opposing players that would normally be unavailable. It is envisioned that players in an online setting would use this insight to better understand opposing players and make game play more competitive and engaging.

The system of the invention may also display player profiles with trophy information, such as the frequency of the skill plays each user has performed historically in addition to other info, some or all of which may be used to gain insight into a player's mannerisms and style of play for purposes of attempting to predict game play.

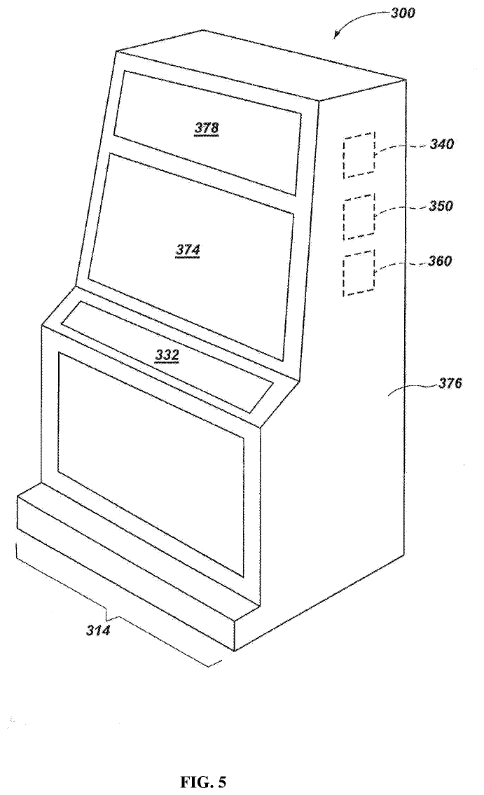

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical implements and live personnel. The action may instead be simulated by a control processor 350 operably coupled to the memory 340 and interacting with and controlling the individual electronic gaming device 300.

Although the individual electronic gaming device 300 displayed in FIG. 4 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices such as a server through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play.

Some embodiments may be implemented at locations including a plurality of player stations. Such player stations may include an electronic display screen for display of game information (e.g., tiles, grids, wagers, animations and game instructions) and for accepting wagers and facilitating credit balance adjustments. Such player stations may, optionally, be integrated in a table format, may be distributed throughout a casino or other gaming site, or may include both grouped and distributed player stations.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

In some embodiments, players may play a head to head or tournament version utilizing the gaming methods as described herein wherein players compete against one another or others. Players may begin with the same initial tiles in the same positions on a grid and then proceed with the winning player being the player having the most credits after a certain amount of game play or time has transpired.

FIG. 5

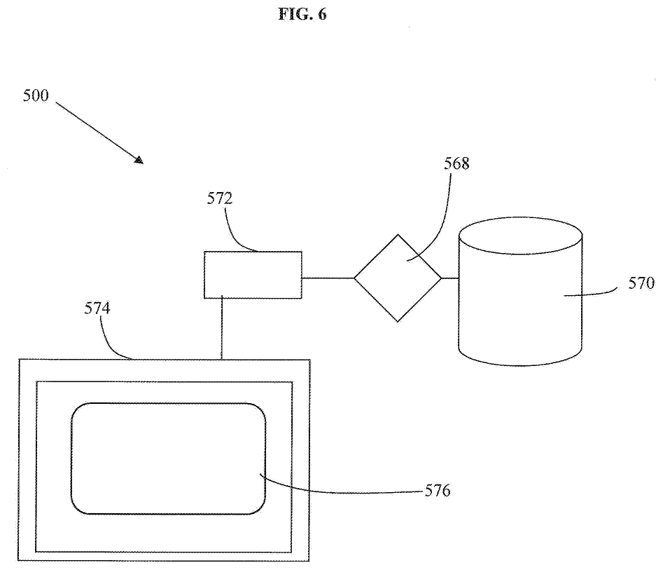

FIG. 6 illustrates a diagram of an exemplary system 500, which may be a portable device, constructed in accordance with some embodiments of the invention. System 500 includes processing device 568 in communication with a database or memory device 570, communication or data input/output device 572 and a display device 574. In some embodiments, display device 574 is a touch-enabled device and includes a data input device component. Memory device 570 may include data relating to the underlying game and embodiments of the invention as described herein, such as the tiles, game play and wagering events. A player interface 576 can be presented on display device 574. Player interface 576 may be a virtual representation of an interface for facilitating game play in accordance with any of the embodiments herein. Game play and wagering event outcomes are displayed and tracked using display device 574 and processing device 568.

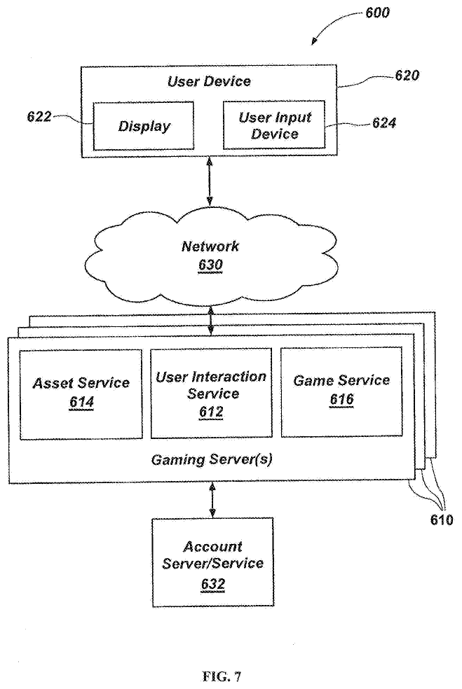

In some embodiments, games in accordance with this disclosure may be administered using a gaming system employing a client-server architecture (e.g., over the Internet, a local area network, etc.). FIG. 7 is a schematic block diagram of an exemplary gaming system 600 for implementing games of the invention so that end users may remotely access games as described herein, among others.

The wagering games supported by the gaming system 600 may be operated with real currency or with virtual credits or other virtual (e.g., electronic) value indicia. For example, the real currency option may be used and currency cashed out at the end of a game session. The virtual credits option may be used with games of the invention in which credits may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated.

The gaming system 600 may include a gaming platform to establish a portal for an end user to access a wagering game hosted by one or more gaming servers 610 over a network 630. In embodiments, games of the invention are accessed through a user interaction service 612. The gaming system 600 enables players to interact with a user device 620 through a user input device 624 and a display 622 and to communicate with one or more gaming servers 610 using a network 630 (e.g., the Internet). Typically the user device is remote from the gaming server 610 and the network is the word-wide web (i.e., internet).

In some embodiments, the gaming servers 610 may be configured as a single server to administer wagering games in combination with the user device 620. In other embodiments, the gaming servers 610 may be configured as separate servers for performing separate, dedicated functions associated with administering games of the invention. Accordingly, the following description also discusses “services” with the understanding that the various services may be performed by different servers or combinations of servers in different embodiments. As shown in FIG. 7, the gaming servers 610 may include a user interaction service 612, a game service 616, and an asset service 614. In some embodiments, one or more of the gaming servers 610 may communicate with an account server 632 performing an account service 632. As explained more fully below, for some games disclosed herein, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may comprise game rules, such as those relating to the grid and/or tile generation and wagering events. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script, also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of any game of the invention, such as game 102. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, non-limiting example, the user device 620 operating the client may be an interactive electronic gaming system 400 (see FIG. 4) or portable system 500 (see FIG. 6), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept wagers and make payout distributions. The gaming servers 610 may communicate with the account service 632 to verify the existence of funds for wagering and to instruct the account service 632 to execute debits and credits. As another example, the gaming servers 610 may directly accept wagers upon a wagering event occurring and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations.

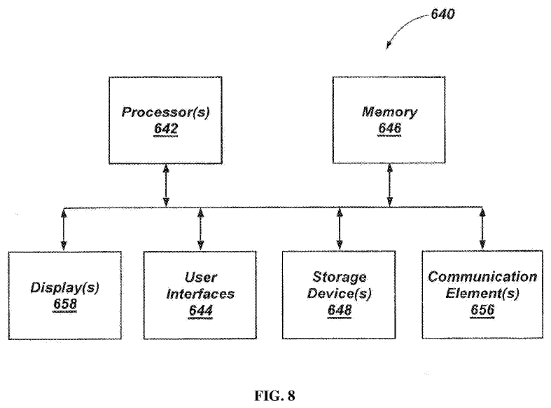

FIG. 8 is a simplified block diagram showing elements of computing devices that may be used in systems and apparatuses of this disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The memory 646 may be used to hold computing instructions, data, and other information for performing a wide variety of tasks including administering games of the invention, such as game 102. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one non-limiting example, the memory 646 may be divided into cache memory, graphics memory, and main memory. Each of these memories may communicate directly or indirectly with the one or more processors 642 on separate buses, partially-combined buses, or a common bus.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Additional information regarding exemplary embodiments of the invention is provided below.

### Computer Program

In some embodiments, the methods, systems, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™ and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CS S). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the methods, systems, and media disclosed herein include one or more databases, or use of the same. In view of the disclosure provided herein, those of skill in the art will recognize that many databases are suitable for storage and retrieval of player and game information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based.

In still further embodiments, a database is cloud computing-based. In other embodiments, a database is based on one or more local computer storage devices.

### General Information Relating to Various Embodiments of the Invention

A controller, computing device, or computer, such as described herein, may include at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

In some embodiments, a controller may include a processor, which as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system, gaming device, gaming machine or incorporated in an existing gaming system or machine. The gaming machine of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

Those skilled in the art will readily appreciate that the apparatus described herein may include various computer and network related software and hardware, such as programs, operating systems, memory storage devices, data input/output devices, data processors, servers with links to data communication systems, wireless or otherwise, and data transceiving terminals. Those skilled in the art will further appreciate that the precise types of software and hardware used are not vital to the full implementation of the apparatus of the invention so long as it performs as described in at least one of the embodiments herein.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth by the claims and any equivalents thereto.

1. A gaming system, comprising:
at least one processor;
at least one input device;
and at least one memory device that stores a plurality of instructions that, when executed by the at least one processor, cause the at least one processor to operate with the at least one display device and the plurality of input devices to:
(a) establish a first player account with a credit balance associated with a first player;
(b) accept the first player in a wagering game involving play against one or more second players, each second player having a second player account;
(c) responsive to the occurrence of a game event requiring a player action, receive game event data relating to the first and second player actions and game conditions at the occurrence of the game event;
(d) determine a rank of each of the first and second player actions based at least partially on the game conditions;
(e) distribute one of (i) an award from a second player to the first player as an indicator of skilled play responsive to the rank of the first player action outranking the rank of the second player action and (ii) an award from the first player to the second player as an indicator of skilled play responsive to the second player action outranking the rank of the first player action; and
(f) display the distributed award in the first or second player account.

2. A computer implemented gaming method having a feature for distributing awards for skilled game play, comprising the steps of:
a) establishing a first player account with a credit balance associated with a first player;
b) accepting the first player in a wagering game involving play against one or more second players, each second player having a second player account;
c) responsive to the occurrence of a game event requiring a player action, receiving game event data relating to the first and second player actions and game conditions at the occurrence of the game event;
d) determining a rank of each of the first and second player actions based at least partially on the game conditions;
e) distributing one of (i) an award from a second player to the first player as an indicator of skilled play responsive to the rank of the first player action outranking the rank of the second player action and (ii) an award from the first player to the second player as an indicator of skilled play responsive to the second player action outranking the rank of the first player action; and
f) displaying the distributed award in the first or second player account.
